(19) United States
(12) Patent Application Publication
(10) Pub. No.: US 2025/0082135 A1
(43) Pub. Date: Mar. 13, 2025

(54) FOOD PROCESSOR ARRANGEMENT AND CHOPPING ASSEMBLY FOR A FOOD PROCESSOR

(71) Applicant: Wundermix GmbH, Garching b. München (DE)

(72) Inventor: Adrian Keusgen, Endingen am Kaiserstuhl (DE)

(21) Appl. No.: 18/552,818

(22) PCT Filed: Jan. 9, 2023
(86) PCT No.: PCT/EP2023/050331

§ 371 Date: Sep. 27, 2023

(30) Foreign Application Priority Data
Apr. 27, 2022 (DE) 10 2022 110 290.4

(51) Int. Cl. A47J 43/08; A47J 43/07; A47J 43/25

(52) U.S. Cl. CPC A47J 43/085; A47J 43/0772; A47J 43/255

(57) ABSTRACT

A food processor arrangement including a food processor assembly and a chopping assembly, wherein the chopping assembly and the food processor assembly are assembled to form an operating state setup in order to provide a chopping operating state of the food processor arrangement for chopping food, such as vegetables and/or fruit.

A chopping assembly for the mentioned food processor arrangement is also related. The chopping assembly is formed to be assembled with the food processor assembly to form an operating state setup in order to provide a chopping operating state of the food processor arrangement for chopping food, such as vegetables and/or fruit. Advantageously.

The operational and user safety is configured to be improved when chopping food using the proposed food processor arrangement and the chopping assembly.

### CROSS-REFERENCE TO RELATED APPLICATIONS

This application is a 35 U.S.C. § 371 National Stage patent application of PCT/EP2023/050331, filed on 9 Jan. 2023, which claims the benefit of German patent application 10 2022 110 290.4, filed on 27 Apr. 2022, the disclosures of which are incorporated herein by reference in their entirety.

### TECHNICAL FIELD

The present disclosure relates to a food processor arrangement comprising a food processor assembly and a chopping assembly, wherein the chopping assembly and the food processor assembly are assembled to form an operating state setup in order to provide a chopping operating state of the food processor arrangement for chopping food, such as vegetables and/or fruit.

The disclosure further relates to a chopping assembly for the mentioned food processor arrangement, wherein the chopping assembly is formed to be assembled with the food processor assembly to form an operating state setup in order to provide a chopping operating state of the food processor arrangement for chopping food, such as vegetables and/or fruit.

In the context at hand, a “food processor” can also be referred to as “food processor assembly”.

### BACKGROUND

By nature, the chopping of food, such as vegetables (e.g. zucchini), fruit (e.g. apples), but also potatoes is associated with high effort, at least when this takes place manually with the help of a knife or another manually operated chopping tool. Such a manual chopping of food is associated with a high expenditure of time, a risk of injury for the user, and with a limited variety of shapes (of the chopped food). Electric kitchen aids are also known, by means of which food can be chopped, for example potatoes are cut into slices. It is disadvantageous in the case of such electric kitchen aids, which are limited to a concrete functionality that additional space is required in the kitchen for the storage thereof.

In addition to other functions (e.g. heating, mixing), multi-function food processors, as sold, for example, under the brand Thermomix®, can further also be used to chop food. With regard to this, reference is made, for example, to the publication EP 3 936 014 A1. The setup therein adopts the rotation function of a mixing tool arranged in a food preparation vessel, in order to transfer a rotational movement performed by the mixing tool via an adapter to a cutting disk. Food can then be brought into contact with the rotating cutting disk for chopping purposes. If the lid is not attached, a user can possibly come into physical contact with the cutting disk attached to the adapter (even if said cutting disk does not rotate when the lid is attached). There is thus a need for further improving the safety in the case of such food processors.

Food processors are also known, in the case of which a direct contact of a user with the rotating chopping tool cannot be ruled out even during rotation of a chopping tool (e.g. a cutting disk). There is thus a basic need for improving the operational and user safety of food processors, which are used to chop food.

With corresponding chopping assemblies (comprising, e.g., a chopping tool), food processor assemblies can form a food processor arrangement.

### SUMMARY

On the one hand, the present disclosure provides an alternative for known food processor arrangements or chopping assemblies for them, respectively. On the other hand, to the disclosure also improves the operational and user safety of food processor arrangements or chopping assemblies used therewith, respectively, when chopping food. It is likewise an advantage of the disclosure to propose a chopping assembly, which can be used with high operational and user safety in different food processor models.

The disclosure provides a food processor arrangement comprising the features of claim 1 and a chopping assembly comprising the features of claim 23.

The present disclosure initially relates to a food processor arrangement, comprising a food processor assembly and a chopping assembly, wherein the chopping assembly and the food processor assembly are assembled to form an operating state setup in order to provide a chopping operating state of the food processor arrangement for chopping food, such as vegetables and/or fruit.

The food processor assembly comprises:
a. a drive unit;
b. a rotatably mounted rotation unit, which, in the operating state setup, can be rotated by using the drive unit.

The chopping assembly comprises:
c. a collecting pot for collecting chopped food, wherein the collecting pot has a collecting pot interior, which is limited to the outside by means of a collecting pot bottom and a collecting pot jacket, wherein, in the operating state setup, a collecting pot opening located opposite the collecting pot bottom is covered by means of a collecting pot lid;
d. an adapter shaft, which, in the operating state setup, is coupled with a first adapter shaft end to the rotation unit, so that a rotation of the rotation unit transfers directly to the adapter shaft, wherein, in the operating state setup, the adapter shaft extends with a second adapter shaft end located opposite the first adapter shaft end all the way into the collecting pot interior,
e. a support shaft, which is separate from the adapter shaft and which is received with a first support shaft end in the collecting pot lid so as to be secured against axial displacement with respect to a support shaft longitudinal axis and which is rotatably mounted about the support shaft longitudinal axis, wherein the support shaft has a second support shaft end, which is located opposite the first support shaft end and which, in the operating state setup, is coupled to the second adapter shaft end, so that a rotation of the rotation unit and of the adapter shaft transfers directly to the support shaft;
f. a chopping tool, which, in the operating state setup, is supported by the support shaft and is arranged in a rotationally fixed manner relative to said support shaft.

The mentioned “operating state setup” can be understood thereby as assembled state of the food processor assembly and of the chopping assembly to form a common structural unit, in which an operation of the food processor arrangement for chopping food is made possible. The operating state setup can relate to a sleep mode (stand-by mode), a turned-off mode, or an active operating mode (in which a chopping of foods takes place actively) of the food processor arrangement. If the food processor assembly and the chopping assembly are not assembled (to form a common structural unit), a chopping of food cannot take place by means of the food processor arrangement. The below-described features refer to a functional, assembled operating state setup of the food processor assembly and of the chopping assembly, in which the chopping of food is made possible when performing a rotation of that rotation unit belonging to the food processor assembly. The rotation (as well as a torque associated therewith) thereby transfers to the chopping tool via the adapter shaft and the support shaft. When a food to be chopped (a chopping material) is brought into contact with the rotating chopping tool, it is chopped. The chopping tool can be formed in a modular manner, whereby differently formed chopping tools can be used, e.g., for different chopping processes (e.g. cutting, grating, shredding, peeling).

In a state, in which it is not assembled with the chopping assembly, the food processor assembly can be used for other purposes. On its own, the food processor assembly preferably provides a multi-function food processor or is part thereof. In addition to the drive unit and the rotation unit, the food processor can also comprise further components, for example a control unit. The drive unit preferably drives the rotation unit via a drive shaft.

With a food process arrangement according to the disclosure, a user is enabled to chop, in particular to cut, to grate, to shred, to slice, to peel, etc. food, such as vegetables, fruit, or potatoes, in particular into geometrically defined shapes (e.g. chunky, noodle-like, spiral-shaped, slice-like, strip-like, flake-like, etc.).

In the described operating state setup, the chopping tool is arranged above the collecting pot bottom, which means that after the chopping, the chopped food falls through the chopping tool in the direction of the collecting pot bottom and is collected in the collecting pot. After the chopping, the food processor arrangement comprising the food processor assembly and the chopping assembly can be disassembled. The collecting pot, together with chopped food contained therein (chopping material) can be removed from the assembled setup and can be used for further purposes. For example, the collecting pot can then be placed into a refrigerator in order to store the chopping material. The collecting pot can be made of plastic or stainless steel. The collecting pot can also be made of several different materials. A grip or a handle can be arranged on the collecting pot lid and/or the collecting pot jacket.

As mentioned, the chopping assembly comprises an adapter shaft, which, in the operating state setup, is coupled with a first adapter shaft end to the rotation unit, so that a rotation of the rotation unit transfers directly to the adapter shaft. The rotation unit thereby transmits a torque to the adapter shaft, is thus connected to the latter in a rotationally fixed manner (torque-proof). The rotation unit can be a knife, a mixing knife, or a mixer. An adaption interface or contact surfaces, respectively, formed in the region of the first adapter shaft end is supported on the rotation unit. The adapter shaft can be made, for example, of stainless steel or plastic.

As mentioned, the chopping assembly comprises a support shaft, which is separate from the adapter shaft and which is received with a first support shaft end in the collecting pot lid so as to be secured against axial displacement with respect to a support shaft longitudinal axis and which is rotatably mounted about the support shaft longitudinal axis. Even if the chopping assembly is not assembled with the food processor assembly to form a food processor arrangement, the support shaft is preferably received with a first support shaft end in the collecting pot lid so as to be secured against axial displacement with respect to a support shaft longitudinal axis and is rotatably mounted about the support shaft longitudinal axis. In this case, the support shaft can thus not be separated from the collecting pot lid without undue force from the user. Due to the fact that, in the operating state setup, the chopping tool is supported by the support shaft (which is connected to the collecting pot lid), a rotation of the chopping tool is only possible when the collecting pot lid is attached to the collecting pot jacket or covers the collecting pot opening, respectively. The risk that a user gets injured on the chopping tool, is therefore reduced significantly.

The designs of the food processor arrangement specified in the subclaims will be described below. They can be advantageous designs of the food processor arrangement on their own, but also of the likewise claimed chopping assembly. The described designs can thus be advantageous designs of the disclosure as a whole (also beyond category boundaries). Designs, which are not listed in the claims, will also be described below. These designs can also be advantageous designs of the disclosure.

According to a first design of the disclosure, it can be provided that the food processor assembly has a preparation pot comprising a preparation pot interior, which is limited to the outside by means of a preparation pot bottom and a preparation pot jacket, wherein, in the operating state setup, a preparation pot opening located opposite the preparation pot bottom is covered by means of a preparation pot lid, wherein the preparation pot lid has a preparation pot filling opening with a smaller diameter than the preparation pot opening, and wherein the rotation unit is arranged in the vicinity of the preparation pot bottom. Many different known food processor assemblies (e.g. the Thermomix® 5, 6, 31 from the manufacturer Vorwerk and the food processor Monsieur Cuisine sold by the retailer “Lidl”) comprise such a preparation pot. The chopping assembly can thus be combined with preparation pots from different manufacturers and can functionally cooperate with them.

According to a further design of the disclosure, it can be provided that, in the operating state setup, the collecting pot is attached to the preparation pot lid of the preparation pot, in particular in such a way that a—preferably cylindrically formed—collecting pot collar, which is arranged on an underside of the collecting pot bottom, bears on the preparation pot lid, and/or that the underside of the collecting pot bottom bears on a—preferably cylindrically formed—preparation pot lid collar, which is arranged on the preparation pot lid. The cylindrically formed collecting pot collar and/or the cylindrically formed preparation pot lid collar can have a circumferentially continuous cylindrical shape or can have material apertures, can thus comprise a plurality of webs forming the respective collars. The collecting pot collar can form a foot of the collecting pot. It can be provided that the collecting pot collar supports itself at least partially on the preparation pot lid collar or vice versa, and thus forms a protection against displacement of the collecting pot with respect to the preparation pot in the radial direction. The support is thereby provided by means of corresponding jacket surfaces of the respective collars. The attachment of the collecting pot onto the preparation pot provides for a particularly simple assembly (connection) of the collecting pot with the preparation pot.

According to a further design of the disclosure, it can be provided that an adapter shaft through opening is formed in the collecting pot bottom, through which the adapter shaft is guided in the operating state setup, wherein, in the operating state setup, the adapter shaft through opening is arranged centrally to the preparation pot filling opening in the radial direction, and wherein the adapter shaft through opening has a smaller diameter than the preparation pot filling opening. The adapter shaft through opening is preferably a hole opening, which can have any contour geometry (hole geometry), the adapter shaft through opening can be, for example, a hole opening with cylindrical or polygonal hole geometry. The diameter of the adapter shaft through opening preferably corresponds essentially to an outer diameter of the adapter shaft, which is guided through the adapter shaft through opening in the operating state setup. If the adapter shaft is formed to taper along its longitudinal axis, the adapter shaft through opening has a diameter, which corresponds at least to the largest outer diameter of that very longitudinal section of the adapter shaft, which, in the operating state setup, is guided through the adapter shaft through opening, or is larger than said diameter. The adapter shaft through opening and the adapter shaft are preferably constructed so that chopping material collecting in the collecting pot does not reach into the preparation pot. The latter thus does not need to be cleaned separately after the chopping.

According to a further design of the disclosure, it can be provided that, in the operating state setup, the adapter shaft, starting at the first adapter shaft end coupled to the rotation unit, extends through the preparation pot interior and the adapter shaft through opening all the way into the collecting pot interior, wherein the second adapter shaft end ends in the collecting pot interior. With regard to the overall setup of the food processor arrangement, the adapter shaft is thus preferably arranged and positioned in a centered manner.

According to a further design of the disclosure, it can be provided that on the underside of the collecting pot bottom—in the radial direction between the adapter shaft through opening and an outer circumferential edge of the collecting pot bottom—a fastening collar is formed, which extends cylindrically away from the underside of the collecting pot bottom, starting on the underside of the collecting pot bottom. The fastening collar can have a continuous cylindrical shape or can have material apertures, thus comprise a plurality of fastening webs forming the fastening collar, which are lined up in a circle spaced apart from one another. The fastening webs then form a cylindrical string of fastening webs, wherein the fastening webs do not touch one another.

According to a further design of the disclosure, it can be provided that the fastening collar is formed and dimensioned in such a way that, in the operating state setup, it engages with the preparation pot filling opening, wherein fastening means are arranged on the fastening collar, which provide a protection against an axial displacement of the collecting pot relative to the preparation pot when the fastening collar engages with the preparation pot filing opening. An unwanted release or spinning away of the collecting pot from the preparation pot when chopping the food is prevented thereby, which contributes significantly to the user and operational safety. As such, the fastening collar additionally provides a protection again displacement of the collecting pot in the radial direction during the engagement with the preparation pot filling opening, namely with respect to the preparation pot. A displacement of release of the collecting pot relative to the preparation pot is thus also prevented in the radial direction.

According to a further design of the disclosure, it can be provided that the fastening means are several locking lugs, which are formed on the fastening collar and which, during the engagement of the fastening collar with the preparation pot filling opening, lock with the preparation pot lid, and/or wherein the fastening means are means for providing bayonet closure connections, which, when the fastening collar engages with the preparation pot filling opening, form bayonet closure connections with the preparation pot lid. A corresponding fastening means (locking lug or means for providing bayonet closure connections) can be formed on one or several of the mentioned fastening webs. These fastening means can also be formed on a fastening collar, which is formed in continuous cylindrical shape. The fastening means provide for an axial and/or radial securing of the collecting pot with respect to the preparation pot.

According to a further design of the disclosure, it can be provided that a polygonal, in particular hexagonal, outer contour is formed on the second adapter shaft end in a contour section. According to a further design of the disclosure, it can be provided that the support shaft comprises a support sleeve, which, on a first support sleeve end, has a first sleeve receptacle, which forms the second support shaft end and has a polygonal, in particular hexagonal, inner contour. According to a design of the disclosure, it can be provided that, in the operating state setup, the contour section engages at least partially with the first sleeve receptacle and forms a non-positive and/or positive connection with the latter, wherein the outer contour of the contour section corresponds to the inner contour of the first sleeve receptacle. In the case of the cooperation of a polygonal outer and inner contour, a positive connection can be provided, which is advantageous for an efficient and safe torque transmission from the adapter shaft to the support shaft.

According to a further design of the disclosure, it can be provided that the adapter shaft is formed to taper in the direction of the second adapter shaft end at least in the region of the contour section. Provided that the first sleeve receptacle does not have a tapering shape but a constant diameter, a non-positive connection can be provided between contour section and first sleeve receptacle when the contour section engages with the first sleeve receptacle, which complicates a release of the support shaft from the adapter shaft in the axial direction and thus contributes significantly to the operational and user safety. The non-positive connection can take place by pushing the first sleeve receptacle onto the contour section or by plugging the contour section into the first sleeve receptacle. Such a non-positive connection also counteracts a rotation between adapter shaft and support shaft to a certain extent during the rotation thereof, thus contributes to a rotationally fixed connection of the adapter shaft and support shaft.

According to a further design of the disclosure, it can be provided that in the region of the first support sleeve end, the support sleeve has a beveled run-on section, which provides for a simplified coupling of the second support shaft end to the second adapter shaft end. The run-on section in particular provides for a simplified sliding or insertion of the contour section into the first sleeve receptacle. The beveled run-on section thus widens conically in the direction of the contour section and simplifies the positioning of both components even in the case of initial inclination. The run-on section thus provides for a self-alignment between contour section and first sleeve receptacle to a certain extent.

According to a further design of the disclosure, it can be provided that, on a second support sleeve end located opposite the first support sleeve end, the support sleeve has a second sleeve receptacle, into which a bearing bolt is inserted, in particular pressed in, in a non-positive manner, positive manner, and/or by means of a substance-to-substance bond with a first bearing bolt end, wherein the bearing bolt is received with a second bearing bolt end located opposite the first bearing bolt end in a bearing receptacle formed in the collecting pot lid so as to be secured against axial displacement with respect to a bearing bolt longitudinal axis, which forms a part of the support shaft longitudinal axis, and is rotatably mounted about the bearing bolt longitudinal axis or the support shaft longitudinal axis, respectively. The bearing bolt as well as the support sleeve connected thereto can preferably not be readily (thus without undue force) released from the collecting pot lid. The bearing bolt can be made of metal (e.g. stainless steel) or plastic. The same applies for the support sleeve.

According to a further design of the disclosure, it can be provided that the chopping tool is a cutting disk, which is connected in a rotationally fixed manner to a cutting disk support sleeve, which protrudes through the cutting disk in a centered manner, wherein, in the operating state setup, the cutting disk support sleeve is releasably pushed onto the support sleeve, and is secured against axial displacement with respect to the support shaft longitudinal axis by means of locking means arranged on the support sleeve, and wherein, when pushed onto the support sleeve, the cutting disk support sleeve is connected to said support sleeve in a rotationally fixed manner. The cutting disk support sleeve can have a polygonal (e.g. hexagonal) inner contour, while the support sleeve can have a polygonal (e.g. hexagonal) outer contour. When the cutting disk support sleeve is pushed onto the support sleeve, a positive connection (between the polygonal contours) can thereby provide the rotationally fixed connection between cutting disk support sleeve and support sleeve. In this context, releasable connection between cutting disk support sleeve and support sleeve means that the cutting disk support sleeve, together with cutting disk, can be released from the support sleeve in the non-mounted (assembled) state of the chopping assembly, but is nonetheless secured against displacement in the axial direction when used in the operating state setup. A rotationally fixed connection between support sleeve and cutting disk support sleeve, which is pushed onto said support sleeve, is preferably also ensured, which, in addition to the described cooperation of the polygonal contours can for example also be provided by means of a non-positive connection (e.g. a press fit) between cutting disk support sleeve and support sleeve or the mentioned locking means. The cutting disk preferably has at least one cutting edge and at least one corresponding cutting opening, through which the chopped food can fall through the cutting disk in the direction of the collecting pot.

According to a further design of the disclosure, it can be provided that the collecting pot lid has a filling nozzle, via which food to be chopped can be pushed (moved) in the direction of the cutting disk by using a pusher, which can be plugged into the filling nozzle. The filling nozzle extends away from a surface of the collecting pot lid facing the outside of the collecting pot and forms a filing channel, which leads into the collecting pot interior. The pusher is thereby generally used manually by a user in order to push the food in the direction of the cutting disk or to continue to supply food, respectively. Due to the combined use of filling nozzle and pusher, the risk of injury for the user with regard to an injury on the rotating chopping tool is further reduced.

According to a further design of the disclosure, it can be provided that, on its inner jacket surface facing the collecting pot interior, the collecting pot jacket has one or several web(s), which extend at least partially in a direction from the collecting pot bottom all the way to the collecting pot opening and which protrude into the collecting pot interior, wherein the web(s) prevents an unwanted attaching of the cutting disk support sleeve, which is connected to the cutting disk, to the second adapter shaft end. The web/the webs decrease the inner diameter in the collecting pot interior in such a way that a cutting disk having a larger outer diameter, with reference to the inner diameter of the collecting pot interior, which is specified by the webs, cannot be attached to the second adapter shaft end and cannot be operated. This has a positive effect on the safety of a user of the food processor arrangement.

According to a further design of the disclosure, it can be provided that, on a second support sleeve end located opposite the first support sleeve end, the support sleeve has a circumferential bearing edge, which is received in a bearing slot formed in the collecting pot lid so as to be secured against axial displacement with respect to the support shaft longitudinal axis and is rotatably mounted about the support shaft longitudinal axis. On the one hand, this design ensures a bearing of the bearing sleeve, which is secure with respect to the axial displacement (and thus also of the chopping tool) in the collecting pot lid, on the other hand, a rotation of the support sleeve with respect to the collecting pot lid, which is positionally fixed during operation, is allowed.

According to a further design of the disclosure, it can be provided that, starting at the bearing edge, the support sleeve has a funnel section, which tapers in a funnel-like manner in the direction of the first support sleeve end, wherein a receiving slot for a chopping tool is formed on a lower end of the funnel section, and wherein, in the operating state setup, a chopping tool is inserted into the receiving slot. Different chopping tools can be inserted in a carriage-like manner into the receiving slot. Means for securing a positionally and rotationally fixed arrangement of the chopping tool with respect to the funnel section of the support sleeve can be provided in the region of the receiving slot and/or on the chopping tool. This design is in particular a variation of the chopping assembly, by means of which vegetables, fruit and/or potatoes can be chopped (cut) in a spiral-shaped or noodle-like manner. According to a further design of the disclosure, it can also be provided in the case of this variation that the collecting pot lid has a filling nozzle. In the operating state setup, said filling nozzle is arranged in alignment with the funnel section. In the operating state setup, food to be chopped can be pushed via the filling nozzle in the direction of the funnel section and of the chopping tool using a pusher, which can be plugged into the filling nozzle.

According to a further design of the disclosure, it can be provided that a rotation lock is arranged on an outer jacket surface of the collecting pot jacket, which has a support flange, which, in the operating state setup, supports itself on a tab and/or a grip arranged on the preparation pot lid. A protection against rotation of the collecting pot with respect to the preparation pot or preparation pot lid, respectively, can thus be provided. The support flange can also be formed so that the latter supports itself on a grip or another component of the preparation pot in order to provide a protection against rotation.

According to a further design of the disclosure, it can be provided that one or several cams, which, in the operating state setup, engage below or engage behind a tab and/or a grip arranged on the preparation pot lid, are arranged on the support flange. Said protection against rotation can thus be further improved and/or an axial protection against displacement/protection against tilting/radial lock can additionally be provided between collecting pot and preparation pot.

The support flange is preferably formed in such a way that the chopping assembly can be used in combination with the preparation pots of different food processor models and a protection against rotation with respect to the respective preparation pots is provided at the same time. The same applies for the cam/the cams arranged on the support flange with respect to said axial protection against displacement/protection against tilting/radial lock.

The chopping tool is preferably made of metal.

The disclosure furthermore relates to a chopping assembly for a food processor arrangement formed according to the disclosure, wherein, to provide a chopping operating state of the food processor arrangement for chopping food, such as vegetables and/or fruit, the chopping assembly is formed to be assembled with the food processor assembly to form an operating state setup.

The chopping assembly comprises:
a. a collecting pot for collecting chopped food, wherein the collecting pot has a collecting pot bottom, a collecting pot jacket, and a collecting pot lid, wherein the collecting pot has a collecting pot interior, which is limited to the outside by means of the collecting pot bottom and the collecting pot jacket, wherein a collecting pot opening located opposite the collecting pot bottom can be covered by means of a collecting pot lid;
b. an adapter shaft, which can be coupled with a first adapter shaft end to a rotation unit of the food processor assembly, so that a rotation of the rotation unit effected by a drive unit of the food processor assembly can be transferred directly to the adapter shaft, wherein the adapter shaft is formed so that, in the operating state setup, the adapter shaft extends with a second adapter shaft end located opposite the first adapter shaft end all the way into the collecting pot interior,
c. a support shaft, which is separate from the adapter shaft and which is received with a first support shaft end in the collecting pot lid so as to be secured against axial displacement with respect to a support shaft longitudinal axis and which is rotatably mounted about the support shaft longitudinal axis, wherein the support shaft has a second support shaft end, which is located opposite the first support shaft end and by means of which the support shaft can be coupled to the second adapter shaft end, so that a rotation of the rotation unit and of the adapter shaft can be transferred directly to the support shaft;
d. a chopping tool, which can be supported by the support shaft and which can be arranged in a rotationally fixed manner relative to said support shaft.

In a particularly advantageous embodiment variation, the chopping assembly is compatible with the food processors Thermomix® 5, 6, 31 from the manufacturer Vorwerk and the food processor Monsieur Cuisine sold by the retailer “Lidl”.

In order to avoid repetitions, the features described above in connection with the description of the food processor arrangement with respect to the chopping assembly will not be repeated again at this point. If certain features of the chopping assembly are worded/identified actively in the context of the description of the food processor arrangement (e.g., “is arranged”; “rotates), it is clear to the person of skill in the art that such a feature can also be worded/identified passively (functionally) (e.g. “can be arranged”; “can be rotated”) in the context of the chopping assembly on its own.

### BRIEF DESCRIPTION OF THE DRAWINGS

Further designs of the disclosure are shown in the below-described figures, in which:

FIG. 1 shows a partially cut schematic side view of a food processor arrangement according to a first exemplary embodiment of the disclosure, in the case of which a food processor assembly and a chopping assembly are assembled to form an operating state setup;

FIG. 2 shows a perspective exploded illustration of a food processor arrangement according to the first exemplary embodiment of the disclosure;

FIG. 3 shows a perspective exploded illustration of a chopping assembly for a food processor arrangement according to a second exemplary embodiment of the disclosure;

FIG. 4 shows the chopping assembly according to FIG. 3 in partially cut schematic side view;

FIG. 5 shows the chopping assembly according to FIG. 4 in side view;

FIG. 6 shows an exploded illustration of the food processor arrangement according to the second exemplary embodiment of the disclosure;

FIG. 7a shows a view of a collecting pot lid of a chopping assembly, which is part of a food processor arrangement according to the second exemplary embodiment of the disclosure;

FIG. 7b shows a view of a collecting pot of a chopping assembly, which is part of a food processor arrangement according to the first and second exemplary embodiment of the disclosure;

FIG. 7c shows a view of an adapter shaft of a chopping assembly, which is part of a food processor arrangement according to the first and second exemplary embodiment of the disclosure;

FIG. 7d, e show views of chopping tools formed in the shape of cutting disks of a chopping assembly, which is part of a food processor arrangement according to the second exemplary embodiment of the disclosure;

FIG. 7f shows a view of a pusher of a chopping assembly, which is part of a food processor arrangement according to the first and second exemplary embodiment of the disclosure;

FIG. 8a shows a perspective view of a collecting pot of a chopping assembly, which is part of a food processor arrangement according to the first and second exemplary embodiment of the disclosure;

FIG. 8b shows a perspective view of the collecting pot according to FIG. 8a from its underside, together with the fastening collars arranged thereon;

FIG. 9 shows a view of an alternative design of the fastening collar shown in FIG. 8b;

FIG. 10 shows a perspective view of the insertion of the adapter shaft into a preparation pot in the case of a food processor arrangement according to the first and second exemplary embodiment of the disclosure;

FIG. 11 shows a perspective view of the attachment of the collecting pot onto the preparation pot in the case of a food processor arrangement according to the first and second exemplary embodiment of the disclosure;

FIG. 12 shows a perspective view of an arrangement comprising preparation pot, inserted adapter shaft, collecting pot attached to the preparation pot, and collecting pot lid in the case of a food processor arrangement according to the second exemplary embodiment of the disclosure;

FIG. 13a shows collecting pot lid and chopping tool of a chopping assembly, which is part of a food processor arrangement according to the second exemplary embodiment of the disclosure;

FIG. 13b shows collecting pot lid and chopping tool from FIG. 13a in the assembled state;

FIG. 14a shows a perspective view of a food processor arrangement according to the second exemplary embodiment of the disclosure;

FIG. 14b shows a perspective view of the food processor arrangement from FIG. 14a together with pusher;

FIG. 15a shows a perspective view of a food processor arrangement according to the second exemplary embodiment of the disclosure;

FIG. 15b shows a side view of the food processor arrangement FIG. from 15a;

FIG. 15c shows an enlarged illustration of a detail from FIG. 15b;

FIG. 16a shows a top view illustration of a food processor arrangement according to the second exemplary embodiment of the disclosure;

FIG. 16b shows an enlarged illustration of a detail from FIG. 16a;

FIG. 17a shows a perspective view of a food processor arrangement according to the second exemplary embodiment of the disclosure;

FIG. 17b shows an enlarged illustration of a detail from 17a;

FIG. 18a shows a side view of a food processor arrangement according to the second exemplary embodiment of the disclosure; and

FIG. 18b shows an enlarged illustration of a detail from FIG. 18a.

### DETAILED DESCRIPTION OF THE DRAWINGS

Components, which act functionally identical or similarly, will be provided with identical reference numerals (also beyond individual exemplary embodiments).

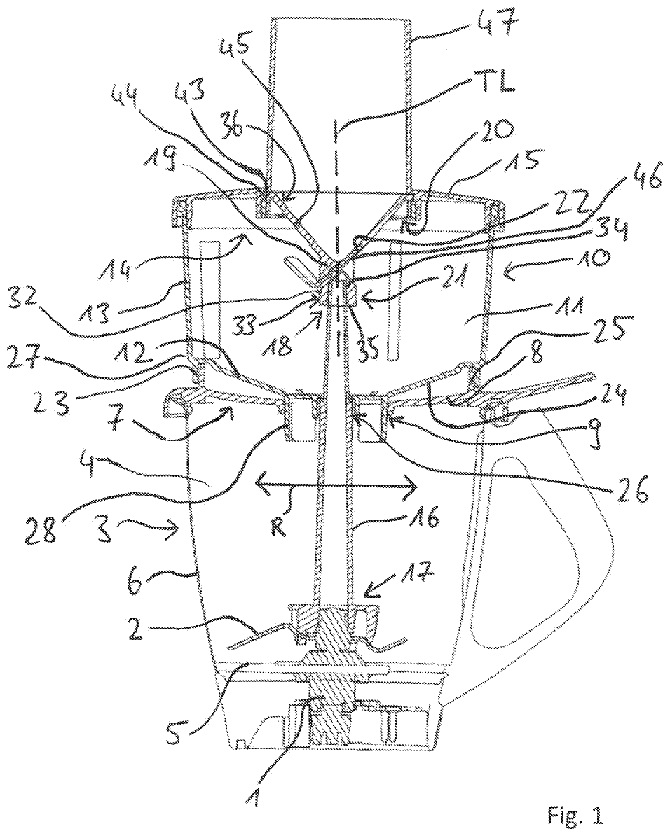

FIG. 1 shows a partially cut schematic side view of a food processor arrangement according to a first exemplary embodiment of the disclosure, in the case of which a food processor assembly and a chopping assembly are assembled to form an operating state setup. The food processor arrangement thus comprises a food processor assembly and a chopping assembly, wherein the chopping assembly and the food processor assembly are assembled to form an operating state setup (as shown, e.g. in FIG. 1) in order to provide a chopping operating state of the food processor arrangement for chopping food, such as vegetables and/or fruit.

The food processor assembly comprises a drive unit 1 and a rotatably mounted rotation unit 2, which, in the operating state setup, can be rotated by using the drive unit 1. The food processor assembly further comprises a preparation pot 3, which has a preparation pot interior 4, which is limited to the outside by means of a preparation pot bottom 5 and a preparation pot jacket 6, wherein, in the operating state setup, a preparation pot opening 7 located opposite the preparation pot bottom 5 is covered by means of a preparation pot lid 8, wherein the preparation pot lid 8 has a preparation pot filling opening 9 with a smaller diameter than the preparation pot opening 7, and wherein the rotation unit 2 is arranged in the vicinity of the preparation pot bottom 5.

The chopping assembly comprises a collecting pot 10 for collecting chopped food, wherein the collecting pot 10 has a collecting pot interior 11, which is limited to the outside by means of a collecting pot bottom 12 and a collecting pot jacket 13, wherein, in the operating state setup, a collecting pot opening 14 located opposite the collecting pot bottom 12 is covered by means of a collecting pot lid 15.

The chopping assembly further comprises an adapter shaft 16, which, in the operating state setup, is coupled with a first adapter shaft end 17 to the rotation unit 2, so that a rotation of the rotation unit 2 transfers directly to the adapter shaft 16, wherein, in the operating state setup, the adapter shaft 16 extends with a second adapter shaft end 18 located opposite the first adapter shaft end 17 all the way into the collecting pot interior 11.

The chopping assembly further comprises a support shaft 19, which is separate from the adapter shaft 16 and which is received with a first support shaft end 20 in the collecting pot lid 15 so as to be secured against axial displacement with respect to a support shaft longitudinal axis TL and which is rotatably mounted about the support shaft longitudinal axis TL, wherein the support shaft 19 has a second support shaft end 21, which is located opposite the first support shaft end 20 and which, in the operating state setup, is coupled to the second adapter shaft end 18, so that a rotation of the rotation unit 2 and of the adapter shaft 16 transfers directly to the support shaft 19.

The chopping assembly furthermore comprises a chopping tool 22, which, in the operating state setup, is supported by the support shaft 19 and is arranged in a rotationally fixed manner relative to said support shaft.

As shown, for example, in FIG. 1, the collecting pot 10 is attached to the preparation pot lid 8 of the preparation pot 3 in the operating state setup. A cylindrically formed collecting pot collar 23 is formed on an underside 24 of the collecting pot bottom 12. The underside 24 of the collecting pot bottom 12 bears on a cylindrically formed preparation pot lid collar 25, which is arranged on the preparation pot lid 8.

An adapter shaft through opening 26 is formed in the collecting pot bottom 12, through which the adapter shaft 16 is guided in the operating state setup, wherein, in the operating state setup, the adapter shaft through opening 26 is arranged centrally to the preparation pot filling opening 9 in the radial direction R, and wherein the adapter shaft through opening 26 has a smaller diameter than the preparation pot filling opening 9. In the operating state setup, the adapter shaft through opening 16 extends, starting at the first adapter shaft end 17 coupled to the rotation unit 2, through the preparation pot interior 4 and the adapter shaft through opening 26 all the way into the collecting pot interior 11, wherein the adapter shaft end 18 ends in the collecting pot interior 11.

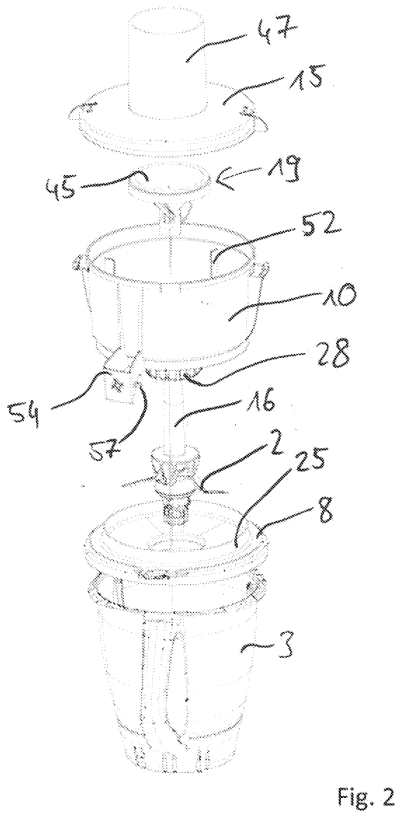

On the underside 24 of the collecting pot bottom 12—in the radial direction R between the adapter shaft through opening 26 and an outer circumferential edge 27 of the collecting pot bottom 12—a fastening collar 28 is formed, which extends cylindrically away from the underside 24 of the collecting pot bottom 12, starting on the underside 24 of the collecting pot bottom 12 (see, e.g., FIG. 1, 4, 5, 6, 8b, 9, 11). The fastening collar 28 thus composed in the shape of a plurality of fastening webs 60 forming the fastening collar 28, which are lined up in a circle spaced apart from one another (see FIG. 2, 5).

The fastening collar 28 is formed and dimensioned in such a way that, in the operating state setup, it engages with the preparation pot filling opening 9, wherein fastening means are arranged on the fastening collar 28, which provide a protection against an axial displacement of the collecting pot 10 relative to the preparation pot 3 when the fastening collar 28 engages with the preparation pot filing opening 9.

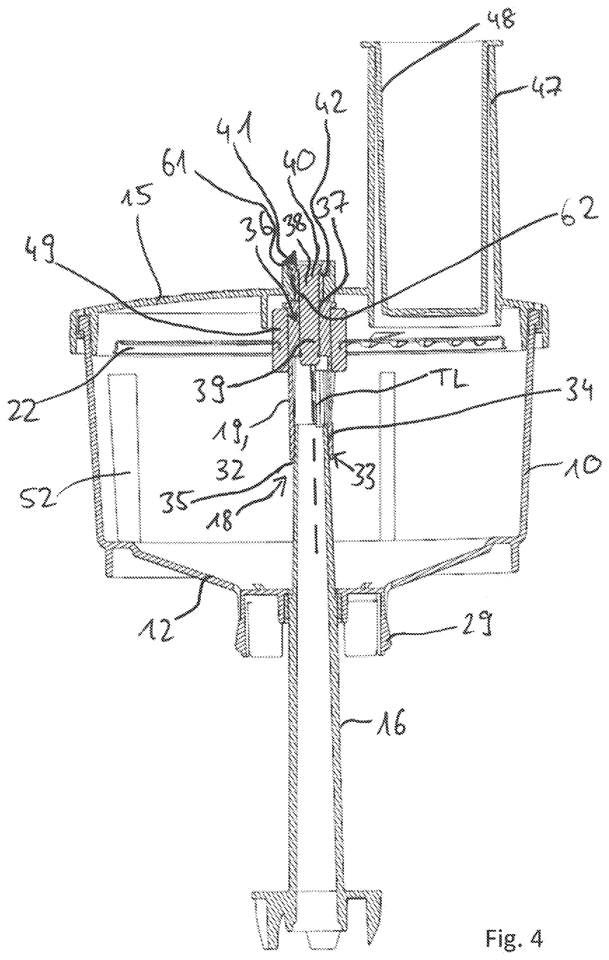

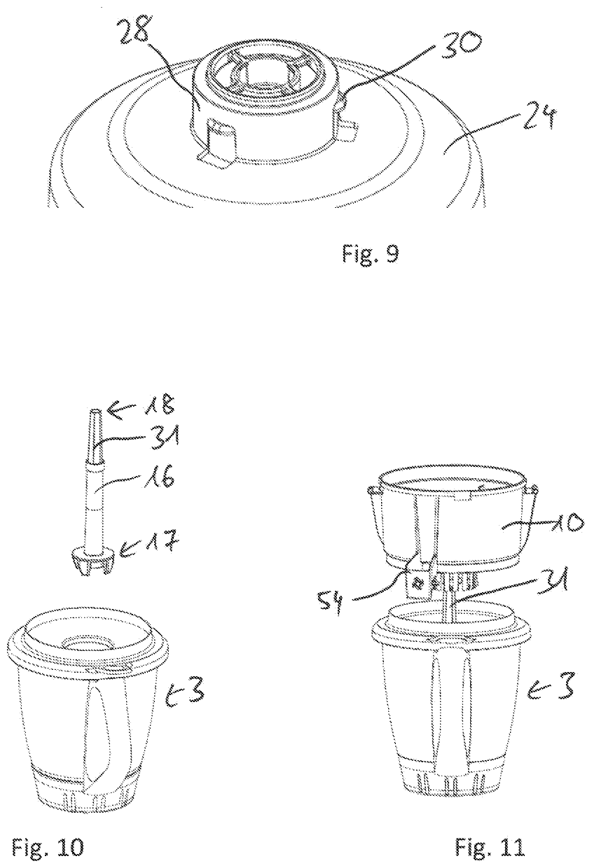

In one variation (see FIG. 4), the fastening means are several locking lugs 29, which are formed on the fastening collar and which, during the engagement of the fastening collar 28 with the preparation pot filling opening 9, lock with the preparation pot lid. In a further variation (FIG. 9), the fastening means are means 30 for providing bayonet closure connections, which, when the fastening collar 28 engages with the preparation pot filling opening 9, form bayonet closure connections with the preparation pot lid 8.

The means 30 can also provide snap closures with the preparation pot lid 8.

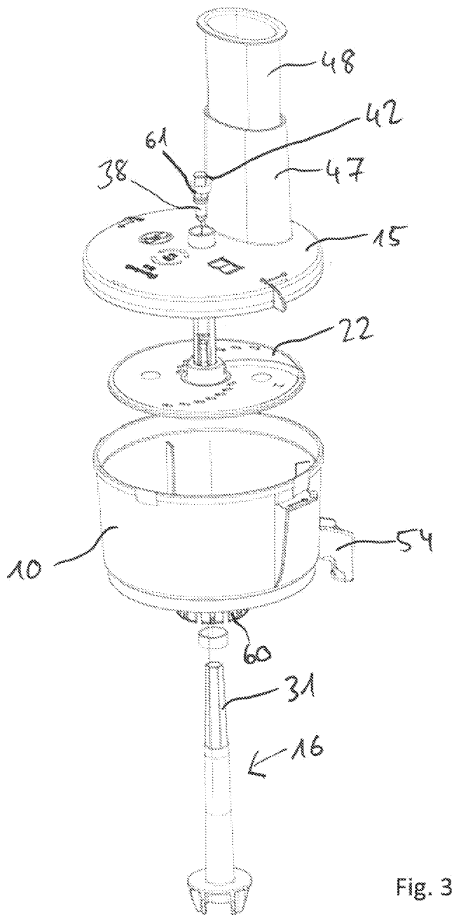

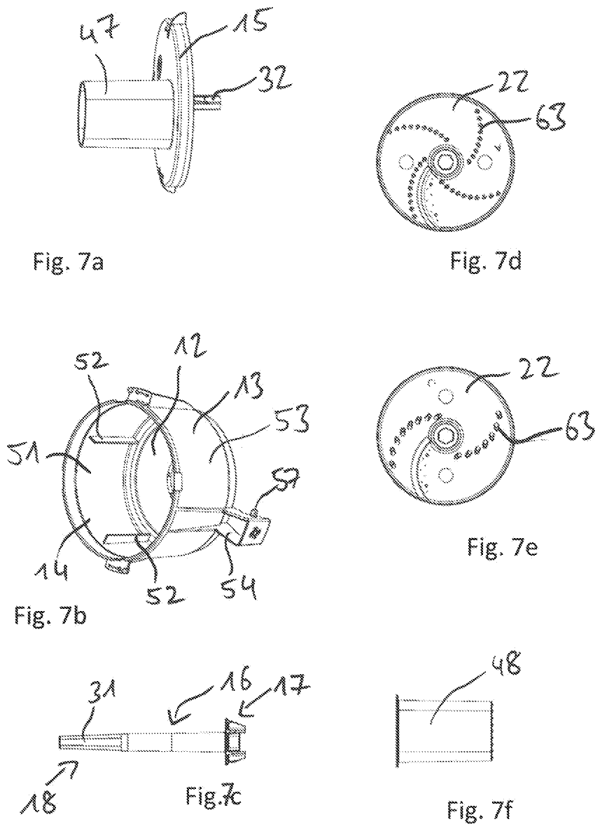

As shown in FIGS. 3 and 7c, a polygonal (here hexagonal) outer contour is formed on the second adapter shaft end 18 in a contour section 31.

The support shaft 19 comprises a support sleeve 32, which, on a first support sleeve end 33, has a first sleeve receptacle 34, which forms the second support shaft end 21 and has a polygonal (here hexagonal) inner contour. In the operating state setup, the contour section 31 engages at least partially with the first sleeve receptacle 34 and forms a non-positive and/or positive connection with the latter, wherein the outer contour of the contour section 31 corresponds to the inner contour of the first sleeve receptacle 34. The adapter shaft 16 is formed to taper in the direction of the second adapter shaft end 18 at least in the region of the contour section 31. In the region of the first support sleeve end 33, the support sleeve 32 has a beveled run-on section 35, which provides for a simplified coupling of the second support shaft end 21 to the second adapter shaft end 18.

In the case of the second exemplary embodiment (see the corresponding figures), the support sleeve 32 has, on a second support sleeve 36 end located opposite the first support sleeve end 33, a second sleeve receptacle 37, into which a bearing bolt 38 is inserted, in particular pressed in with a first bearing bolt end 39 in a non-positive manner, positive manner, and/or by means of a substance-to-substance bond, wherein the bearing bolt 38 is received with a second bearing bolt end 40 located opposite the first bearing bolt end 39 in a bearing receptacle 41 formed in the collecting pot lid 15 so as to be secured against axial displacement with respect to a bearing bolt longitudinal axis, which forms a part of the support shaft longitudinal axis TL, and is rotatably mounted about the bearing bolt longitudinal axis or the support shaft longitudinal axis TL, respectively. As shown in FIG. 4, the bearing receptacle 41 is realized by means of a bearing ring 61, in which the bearing bolt 38 is received with its second bearing bolt end 40. The axial protection against displacement is realized by means of an undercut 42 of the bearing bolt 38 (with respect to the bearing ring 61), as shown, e.g., in FIG. 4. The bearing ring 61 preferably likewise has an undercut 62 relative to a support flange in the collecting pot lid 15.

In the case of the first exemplary embodiment (see the corresponding figures, e.g., FIG. 1), the support sleeve 32 has, on a second support sleeve end 36 located opposite the first support sleeve end 33, a circumferential bearing edge 43, which is received in a bearing slot 44 formed in the collecting pot lid 15 so as to be secured against axial displacement with respect to the support shaft longitudinal axis TL and which is rotatably mounted about the support shaft longitudinal axis TL. Starting at the bearing edge 43, the support sleeve 32 has a funnel section 45, which tapers in a funnel-like manner in the direction of the first support sleeve end 33, wherein a receiving slot 46 for a chopping tool 22 is formed on a lower end of the funnel section 45, and wherein, in the operating state setup, a chopping tool 22 is inserted into the receiving slot 46 (FIG. 1). As further shown in FIG. 1, the collecting pot lid 15 has a filling nozzle 47, which, in the operating state setup, is arranged in alignment with the funnel section 45, and via which, in the operating state setup, food to be chopped can be pushed in the direction of the funnel section 45 and of the chopping tool 22 using a pusher 48, which can be plugged into the filling nozzle.

In the case of the second exemplary embodiment, the chopping tool 22 is a cutting disk (see, e.g., FIG. 3), which is connected in a rotationally fixed manner to a cutting disk support sleeve 49, which protrudes through the cutting disk in a centered manner, wherein, in the operating state setup, the cutting disk support sleeve 49 is releasably pushed onto the support sleeve 32, and is secured against axial displacement with respect to the support shaft longitudinal axis TL by means of locking means 50 arranged on the support sleeve 32, and wherein, when pushed onto the support sleeve 32, the cutting disk support sleeve 49 is connected to said support sleeve in a rotationally fixed manner. This takes place by means of a polygonal inner contour of the cutting disk support sleeve 49 and a polygonal outer contour of the support sleeve 32 (see FIG. 7a in connection with FIG. 7d). In the case of this exemplary embodiment, the collecting pot lid 15 also has a filling nozzle 47, via which food, which is to be chopped in the operating state setup, can be pushed in the direction of the cutting disk using a pusher 48, which can be plugged into the filling nozzle 47.

On its inner jacket surface 51 facing the collecting pot interior 11, the collecting pot jacket 13 has (in the case of both exemplary embodiments) several webs 52, which extend at least partially in a direction from the collecting pot bottom 12 all the way to the collecting pot opening 14 and which protrude into the collecting pot interior 11, wherein the webs 52 prevent an unwanted attaching of the cutting disk support sleeve 49, which is connected to the cutting disk, to the second adapter shaft end 18.

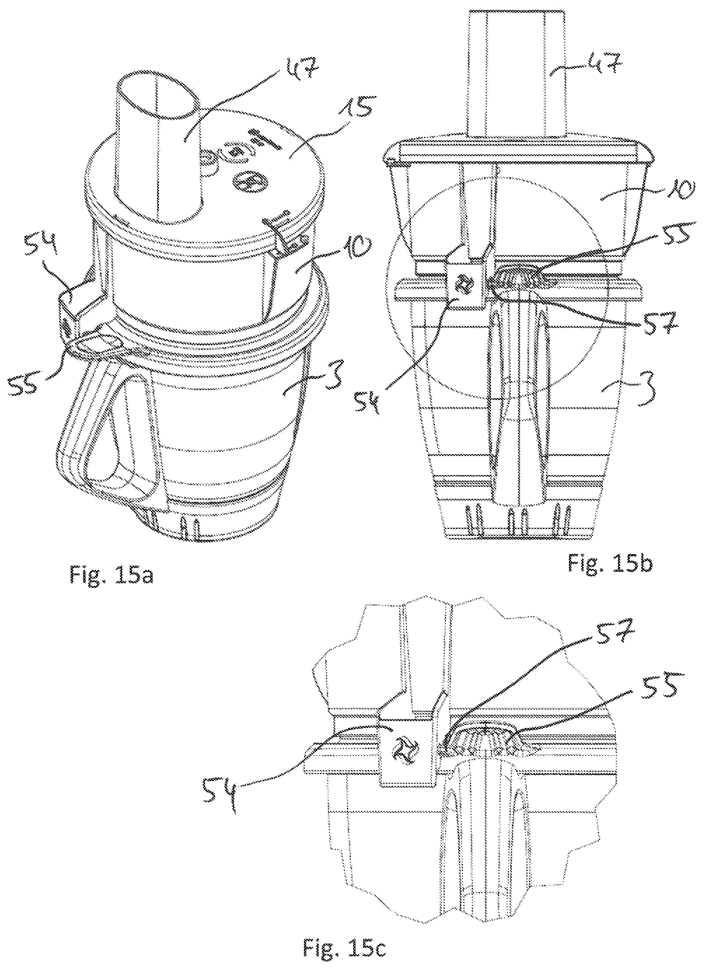

In the case of both exemplary embodiments, a rotation lock is arranged on an outer jacket surface 53 of the collecting pot jacket 13, which has a support flange 54, which, in the operating state setup, supports itself on a tab 55 and/or a grip 56 arranged on the preparation pot lid 8 (FIGS. 15 to 18). A protection against rotation of the collecting pot 10 with respect to the preparation pot 3 or preparation pot lid 8, respectively, is thus provided.

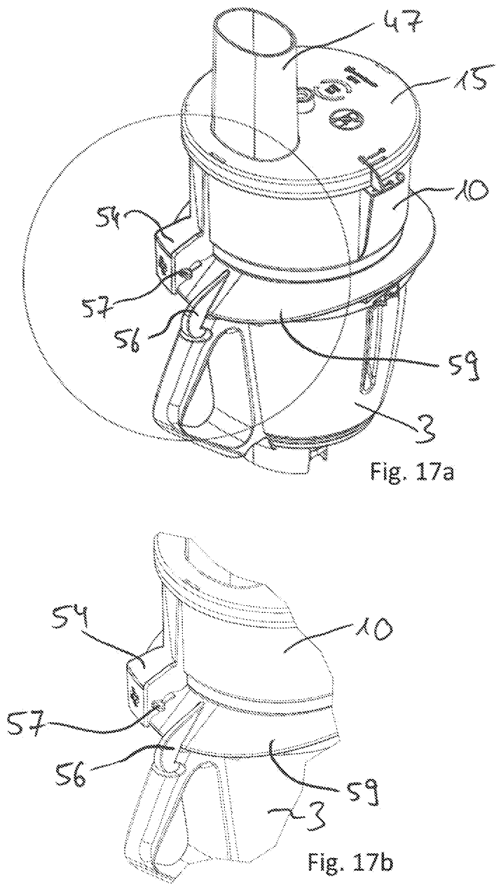

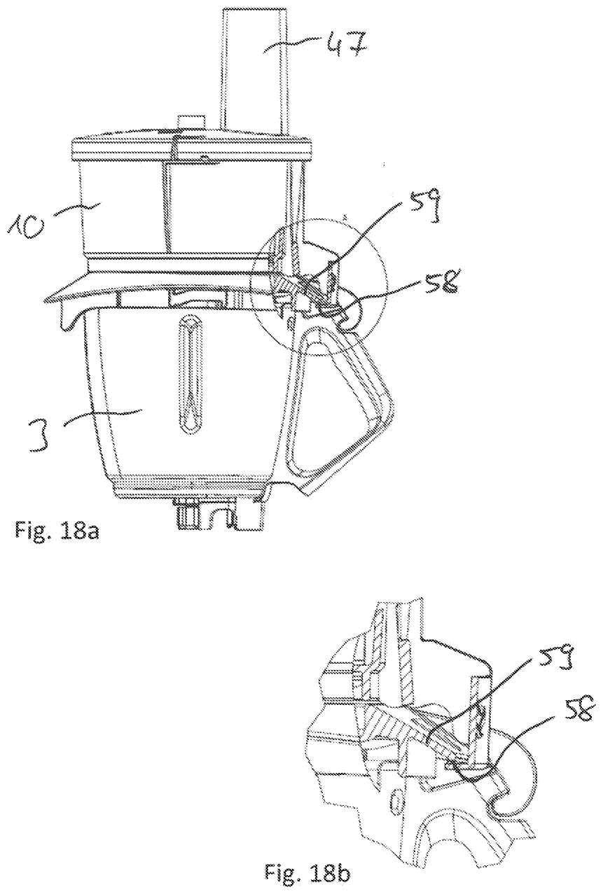

Cams 57, 58, which, in the operating state setup, engage below or engage behind a tab 55, 59 and/or a grip 56 arranged on the preparation pot lid 8, are arranged on the support flange 54. In FIGS. 17a, 17b and 18a, 18b, this is shown for an engaging behind of the tab 59 by means of the cam 58, in FIGS. 15a to c and 16a, 16b for an engaging below the tab 55 by means of the cam 57.

The illustrations of the food processor arrangement shown in the figures will be summarized once again briefly below and will be connected to the above-described statements.

As mentioned, FIG. 1 shows a partially cut schematic side view of a food processor arrangement according to the first exemplary embodiment of the disclosure, in the case of which a food processor assembly and a chopping assembly are assembled to form an operating state setup. The individual features of this illustration have already been explained in detail. FIG. 2 shows a perspective exploded illustration of a food processor arrangement according to the first exemplary embodiment of the disclosure.

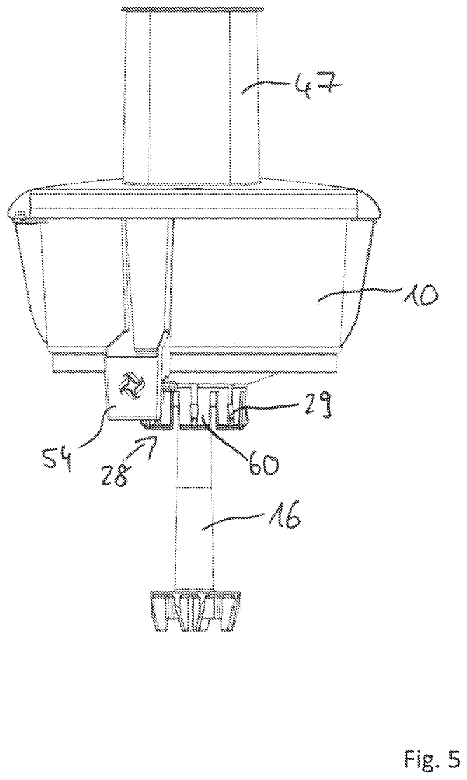

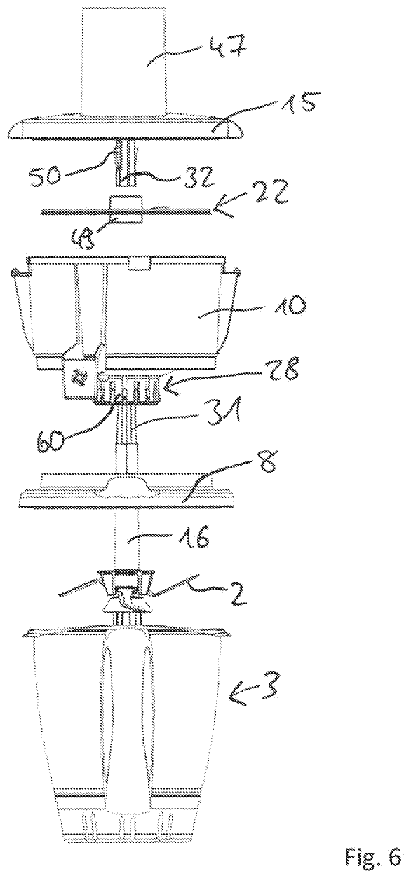

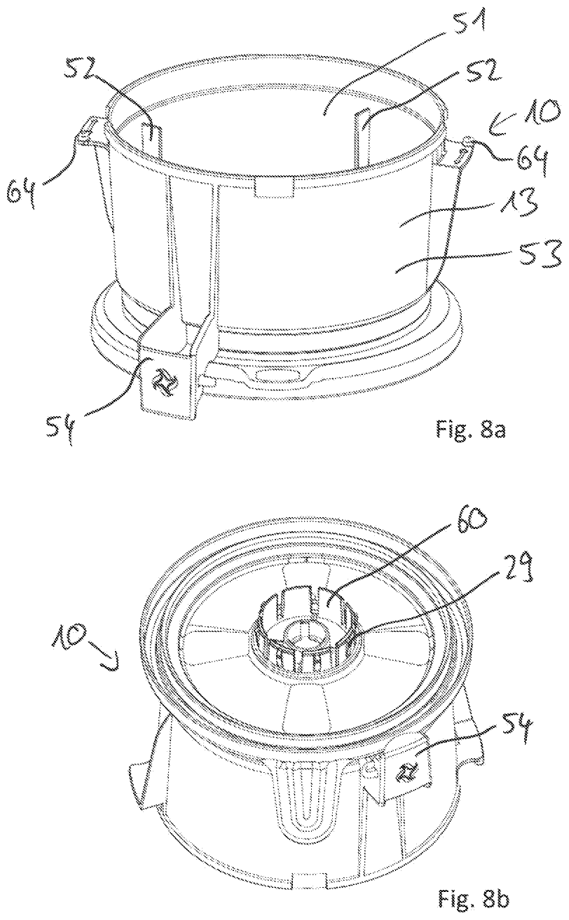

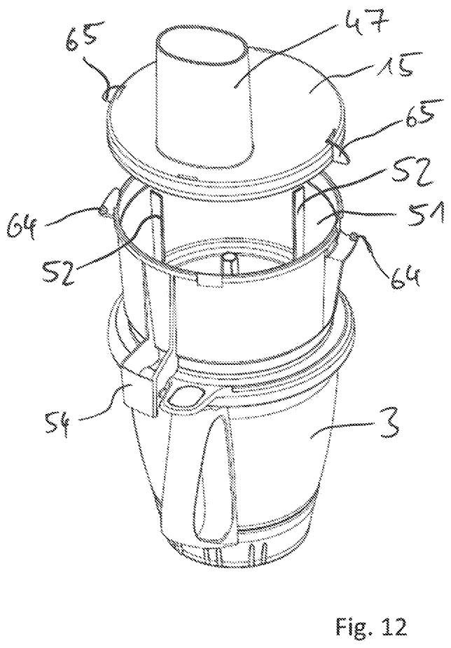

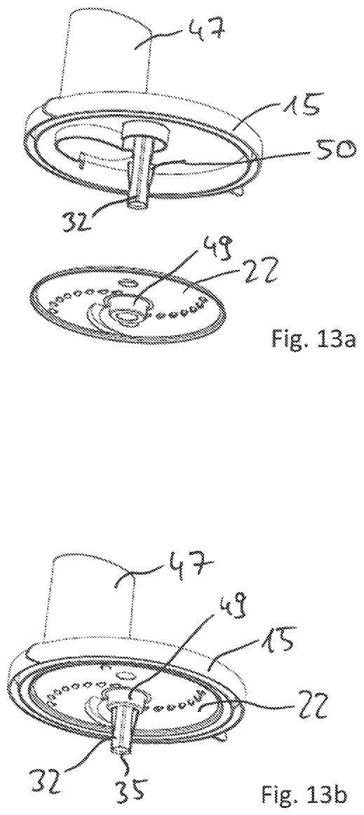

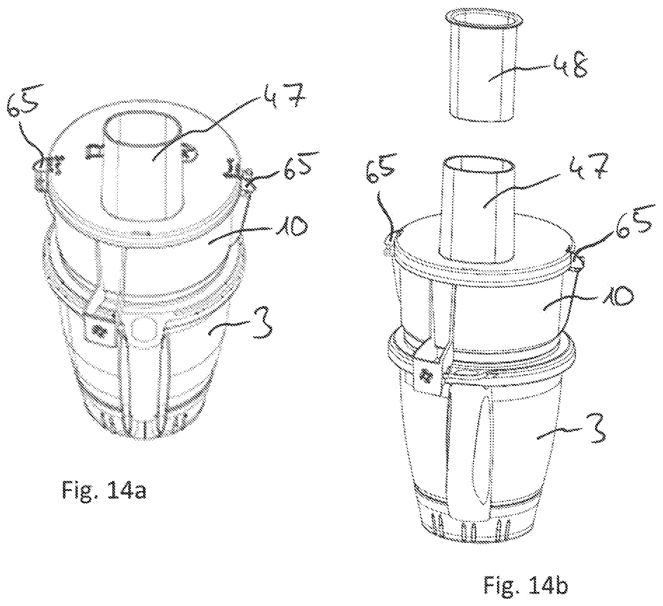

FIG. 3 shows a perspective exploded illustration of the chopping assembly for a food processor arrangement according to the second exemplary embodiment of the disclosure. In contrast to the first exemplary embodiment, the chopping tool 22 is formed as cutting disk. Compared to the first exemplary embodiment, the filling nozzle 47 is also arranged at a different location of the collecting pot lid 15. FIG. 4 shows the chopping assembly according to FIG. 3 (thus according to the second exemplary embodiment) in partially cut schematic side view, but in an assembled state of the components of the chopping assembly. FIG. 5 shows the assembled chopping assembly from FIG. 4 in an uncut side view. FIG. 6 shows an exploded illustration of the food processor arrangement according to the second exemplary embodiment. FIG. 7a shows a view of a collecting pot lid 15 of a chopping assembly, which is part of a food processor arrangement according to the second exemplary embodiment of the disclosure. The filling nozzle 47 as well as the support sleeve 32 with its polygonal outer contour can be seen. FIG. 7b shows a view of a collecting pot 10 of a chopping assembly, which is part of a food processor arrangement according to the first and second exemplary embodiment of the disclosure. In particular the webs 52 and the support flange 54 together with cams 57 can be seen distinctively. FIG. 7c shows a view of an adapter shaft 16 of a chopping assembly, which is part of a food processor arrangement according to the first and second exemplary embodiment of the disclosure. The contour section 31 tapering off in the region of the second adapter shaft end 18 with polygonal outer contour as well as the cross sectional shape of the adapter shaft 16, which tapers in the direction of the second adapter shaft end 18, can be seen distinctively. Views of chopping tools formed in the shape of cutting disks of a chopping assembly, which is part of a food processor arrangement according to the second exemplary embodiment of the disclosure, are shown in FIGS. 7d and 7e. The cutting disks can have different patterns (as needed) of cutting edges 63. Openings, through which the chopping material can fall in the direction of the collecting pot 10 are generally formed on the cutting edges. FIG. 7f shows a view of a pusher 48, which is used in both exemplary embodiments. FIG. 8a shows a perspective view of a collecting pot 10 of a chopping assembly, which is part of a food processor arrangement according to the first and second exemplary embodiment of the disclosure. Stop elements 64, which, as shown in FIGS. 14b and 15a, serve as stop points for bearing wings 65, which are formed on the collecting pot lid 15, can be seen distinctively. They contribute to a protection against rotation of the collecting pot lid 15 with respect to the collecting pot 10. FIG. 8b shows a perspective view of the collecting pot 10 according to FIG. 8a from its underside, together with the fastening collars 28 arranged thereon and the corresponding fastening webs 60. FIG. 9 shows a view of an alternative design of the fastening collar 28 shown in FIG. 8b. In this example, the fastening collar 28 is crafted to be cylindrically continuous, but not in the shape of lined-up fastening webs 60. FIG. 10 shows a perspective view of the insertion of the adapter shaft 16 into a preparation pot 3 in the case of a food processor arrangement according to the first and second exemplary embodiment of the disclosure. FIG. 11 shows a perspective view of the attachment of the collecting pot 10 onto the preparation pot 3 in the case of a food processor arrangement according to the first and second exemplary embodiment of the disclosure. FIG. 12 shows a perspective view of an arrangement comprising preparation pot 3, inserted adapter shaft 16, collecting pot 10 attached to the preparation pot 3, and collecting pot lid 15 in the case of a food processor arrangement according to the second exemplary embodiment of the disclosure. FIG. 13a shows collecting pot lid 15 and chopping tool 22 of a chopping assembly, which is part of a food processor arrangement according to the second exemplary embodiment of the disclosure. The chopping tool 22 is formed as cutting disk here. FIG. 13b shows the collecting pot lid 15 and the chopping tool 22 from FIG. 13a in the assembled state. FIG. 14a shows a perspective view of a food processor arrangement according to the second exemplary embodiment of the disclosure, but without pusher 48, while the latter is shown in FIG. 14b.

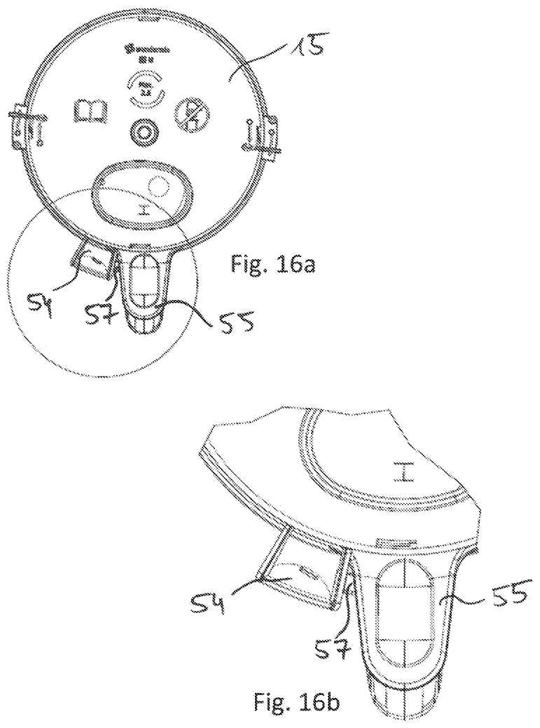

FIG. 15a shows a perspective view of a food processor arrangement according to the second exemplary embodiment of the disclosure. FIG. 15b shows a side view of the food processor arrangement according to FIG. 15a, while FIG. 15c shows an enlarged illustration of a detail from FIG. 15b. The support of the support flange 54 on the tab 55 can be seen distinctively in these figures. This can likewise be seen distinctively in FIGS. 16a and 16b.

FIGS. 17a,b and 18a,b show a perspective view of a food processor arrangement according to the second exemplary embodiment of the disclosure, wherein an engaging behind of the cam 58 with respect to the tab 59 of the preparation pot lid 8 is shown here. In connection with the support flange 54, the cam 58 forms an axial lock and protection against rotation.

The protection against rotation and axial lock of the collecting pot 10 with respect to the preparation pot can be formed analogously in the case of both exemplary embodiments.

1. A food processor arrangement, comprising a food processor assembly and a chopping assembly, wherein the chopping assembly and the food processor assembly are assembled to form an operating state setup in order to provide a chopping operating state of the food processor arrangement for chopping food, such as vegetables and/or fruit,
wherein the food processor assembly comprises:
a. a drive unit;
b. a rotatably mounted rotation unit, which, in the operating state setup, is configured to be rotated by using the drive unit;
wherein the chopping assembly comprises:
c. a collecting pot for collecting chopped food, wherein the collecting pot has a collecting pot interior, which is limited to the outside with a collecting pot bottom and a collecting pot jacket, wherein, in the operating state setup, a collecting pot opening located opposite the collecting pot bottom is covered with a collecting pot lid;
d. an adapter shaft, which, in the operating state setup, is coupled with a first adapter shaft end to the rotation unit, so that a rotation of the rotation unit transfers directly to the adapter shaft, wherein, in the operating state setup, the adapter shaft extends with a second adapter shaft end located opposite the first adapter shaft end all the way into the collecting pot interior,
e. a support shaft, which is separate from the adapter shaft and which is received with a first support shaft end in the collecting pot lid so as to be secured against axial displacement with respect to a support shaft longitudinal axis and which is rotatably mounted about the support shaft longitudinal axis, wherein the support shaft has a second support shaft end, which is located opposite the first support shaft end and which, in the operating state setup, is coupled to the second adapter shaft end, so that a rotation of the rotation unit and of the adapter shaft transfers directly to the support shaft;
f. a chopping tool, which, in the operating state setup, is supported by the support shaft and is arranged in a rotationally fixed manner relative to said support shaft.

2. The food processor arrangement according to claim 1,
wherein the food processor assembly has a preparation pot comprising a preparation pot interior, which is limited to the outside with a preparation pot bottom and a preparation pot jacket, wherein, in the operating state setup, a preparation pot opening located opposite the preparation pot bottom is covered with a preparation pot lid, wherein the preparation pot lid has a preparation pot filling opening with a smaller diameter than the preparation pot opening, and wherein the rotation unit is arranged in the vicinity of the preparation pot bottom.

3. The food processor arrangement according to claim 2, wherein, in the operating state setup, the collecting pot is attached to the preparation pot lid of the preparation pot, that a collecting pot collar, which is arranged on an underside of the collecting pot bottom, bears on the preparation pot lid, and/or that the underside of the collecting pot bottom bears on a preparation pot lid collar, which is arranged on the preparation pot lid.

4. The food processor arrangement according to claim 2, wherein an adapter shaft through opening is formed in the collecting pot bottom, through which the adapter shaft is guided in the operating state setup, wherein, in the operating state setup, the adapter shaft through opening is arranged centrally to the preparation pot filling opening in the radial direction, and wherein the adapter shaft through opening has a smaller diameter than the preparation pot filling opening.

5. The food processor arrangement according to claim 1, wherein, in the operating state setup, the adapter shaft, starting at the first adapter shaft end coupled to the rotation unit, extends through the preparation pot interior and the adapter shaft through opening all the way into the collecting pot interior, wherein the second adapter shaft end ends in the collecting pot interior.

6. The food processor arrangement according to claim 1, wherein, on the underside of the collecting pot bottom in the radial direction between the adapter shaft through opening and an outer circumferential edge of the collecting pot bottom a fastening collar is formed, which extends cylindrically away from the underside of the collecting pot bottom, starting on the underside of the collecting pot bottom.

7. The food processor arrangement according to claim 6, wherein the fastening collar is formed and dimensioned in such a way that, in the operating state setup, it engages with the preparation pot filling opening, wherein fastening means are arranged on the fastening collar, which provide a protection against an axial displacement of the collecting pot relative to the preparation pot when the fastening collar engages with the preparation pot filing opening.

8. The food processor arrangement according to claim 7, wherein the fastening means are several locking lugs, which are formed on the fastening collar and which, during the engagement of the fastening collar with the preparation pot filling opening, lock with the preparation pot lid, and/or wherein the fastening means are means for providing bayonet closure connections, which, when the fastening collar engages with the preparation pot filling opening, form bayonet closure connections with the preparation pot lid.

9. The food processor arrangement according to claim 1, wherein a polygonal outer contour is formed on the second adapter shaft end in a contour section.

10. The food processor arrangement according to claim 1, wherein the support shaft comprises a support sleeve, which, on a first support sleeve end, has a first sleeve receptacle, which forms the second support shaft end and has a polygonal inner contour.

11. The food processor arrangement according to claim 10, wherein, in the operating state setup, the contour section engages at least partially with the first sleeve receptacle and forms a non-positive and/or positive connection with the latter, wherein the outer contour of the contour section corresponds to the inner contour of the first sleeve receptacle.

12. The food processor arrangement according to claim 1, wherein the adapter shaft is formed to taper in the direction of the second adapter shaft end at least in the region of the contour section.

13. The food processor arrangement according to claim 1, wherein, in the region of the first support sleeve end, the support sleeve has a beveled run-on section, which provides for a simplified coupling of the second support shaft end to the second adapter shaft end.

14. The food processor arrangement according to claim 1, wherein, on a second support sleeve end located opposite the first support sleeve end, the support sleeve has a second sleeve receptacle, into which a bearing bolt is inserted, in a non-positive manner, positive manner, and/or with a substance-to-substance bond with a first bearing bolt end, wherein the bearing bolt is received with a second bearing bolt end located opposite the first bearing bolt end in a bearing receptacle formed in the collecting pot lid so as to be secured against axial displacement with respect to a bearing bolt longitudinal axis, which forms a part of the support shaft longitudinal axis, and is rotatably mounted about the bearing bolt longitudinal axis or the support shaft longitudinal axis, respectively.

15. The food processor arrangement according to claim 1, wherein the chopping tool is a cutting disk, which is connected in a rotationally fixed manner to a cutting disk support sleeve, which protrudes through the cutting disk in a centered manner, wherein, in the operating state setup, the cutting disk support sleeve is releasably pushed onto the support sleeve, and is secured against axial displacement with respect to the support shaft longitudinal axis with locking means arranged on the support sleeve, and wherein, when pushed onto the support sleeve, the cutting disk support sleeve is connected to said support sleeve in a rotationally fixed manner.

16. The food processor arrangement according to claim 1, wherein the collecting pot lid has a filling nozzle, via which food, which is to be chopped in the operating state setup, is configured to be pushed in the direction of the cutting disk by using a pusher, which is configured to be plugged into the filling nozzle.

17. The food processor arrangement according to claim 1, wherein, on its inner jacket surface facing the collecting pot interior, the collecting pot jacket has one or several web(s), which extend at least partially in a direction from the collecting pot bottom all the way to the collecting pot opening and which protrude into the collecting pot interior, wherein the web(s) prevents an unwanted attaching of the cutting disk support sleeve, which is connected to the cutting disk, to the second adapter shaft end.

18. The food processor arrangement according to claim 1, wherein, on a second support sleeve end located opposite the first support sleeve end, the support sleeve has a circumferential bearing edge, which is received in a bearing slot formed in the collecting pot lid so as to be secured against axial displacement with respect to the support shaft longitudinal axis and is rotatably mounted about the support shaft longitudinal axis.

19. The food processor arrangement according to claim 18, wherein, starting at the bearing edge, the support sleeve has a funnel section, which tapers in a funnel-like manner in the direction of the first support sleeve end, wherein a receiving slot for a chopping tool is formed on a lower end of the funnel section, and wherein, in the operating state setup, a chopping tool is inserted into the receiving slot.

20. The food processor arrangement according to claim 19, wherein the collecting pot lid has a filling nozzle, which, in the operating state setup, is arranged in alignment with the funnel section, and via which, in the operating state setup, food to be chopped is configured to be pushed in the direction of the funnel section and of the chopping tool using a pusher, which is configured to be plugged into the filling nozzle.

21. The food processor arrangement according to claim 2, wherein a rotation lock is arranged on an outer jacket surface of the collecting pot jacket, which has a support flange, which, in the operating state setup, supports itself on a tab and/or a grip arranged on the preparation pot lid.

22. The food processor arrangement according to claim 21, wherein one or several cams, which, in the operating state setup, engage below or engage behind a tab and/or a grip arranged on the preparation pot lid, are arranged on the support flange.

23. A chopping assembly for a food processor arrangement formed according to claim 1, wherein the chopping assembly is formed to be assembled with the food processor assembly to form an operating state setup in order to provide a chopping operating state of the food processor arrangement for chopping food, such as vegetables and/or fruit,
the chopping assembly comprising:
a. a collecting pot for collecting chopped food, wherein the collecting pot has a collecting pot bottom, a collecting pot jacket, and a collecting pot lid, wherein the collecting pot has a collecting pot interior, which is limited to the outside with the collecting pot bottom and the collecting pot jacket, wherein a collecting pot opening located opposite the collecting pot bottom is configured to be covered with a collecting pot lid;
b. an adapter shaft, which is configured to be coupled with a first adapter shaft end to a rotation unit of the food processor assembly, so that a rotation of the rotation unit effected by a drive unit of the food processor assembly is configured to be transferred directly to the adapter shaft, wherein the adapter shaft is formed so that, in the operating state setup, the adapter shaft extends with a second adapter shaft end located opposite the first adapter shaft end all the way into the collecting pot interior,
c. a support shaft, which is separate from the adapter shaft and which is received with a first support shaft end in the collecting pot lid so as to be secured against axial displacement with respect to a support shaft longitudinal axis and which is rotatably mounted about the support shaft longitudinal axis, wherein the support shaft has a second support shaft end, which is located opposite the first support shaft end and by which the support shaft is configured to be coupled to the second adapter shaft end, so that a rotation of the rotation unit and of the adapter shaft is configured to be transferred directly to the support shaft;
d. a chopping tool, which is configured to be supported by the support shaft and which is configured to be arranged in a rotationally fixed manner relative to said support shaft.
